(19) United States
(12) Patent Application Publication
(10) Pub. No.: US 2009/0125361 A1
(43) Pub. Date: May 14, 2009

(54) METHOD AND SYSTEM FOR PROVIDING PROTECTIVE SERVICES

(75) Inventor: Adam Rossi, Oakton, VA (US)

Correspondence Address: ARENT FOX LLP, 1050 CONNECTICUT AVENUE, N.W., SUITE 400, WASHINGTON, DC, 20036, US

(73) Assignee: Platinum Solutions, Inc., Reston, VA (US)

(21) Appl. No.: 12/263,039

(22) Filed: Oct. 31, 2008

Related U.S. Application Data
(60) Provisional application No. 61/001,117, filed on Oct. 31, 2007.

(51) Int. Cl. G06Q 10/00; G06Q 50/00

(52) U.S. Cl. 705/8; 705/7

(57) ABSTRACT

The present invention relates to a method and system for providing assistance to protective teams in planning, detailing, and organizing protective services. The method and system guides users through the process of capturing relative data and providing a comprehensive set of guidelines to assist protective teams in their duties for protecting people.

### CROSS-REFERENCE TO RELATED APPLICATIONS

This application claims priority to the following of Applicant's co-pending applications:

U.S. Provisional Application No. 61/001,117, titled “Method and System for Providing Protective Services,” filed on Oct. 31, 2007, which is incorporated by reference herein in its entirety.

### BACKGROUND OF THE INVENTION

1. Field of the Invention

The present invention relates generally to a method and system for the protection of Very Important Persons (VIPs). Specifically, the present invention relates to a method and system for providing assistance to protective teams in planning, detailing, and organizing protective services.

2. Background of the Related Art

The protection of VIPs has been and continues to be a critical need of government and other agencies and departments within the protective services community, such as multinational corporations and protective services companies. For many of the smaller agencies or companies, providing a protection detail is a relatively new function and a secondary mission. These smaller agencies generally make use of operation protocols and procedures that are not directly applicable to smaller protective details, as they were designed for larger organizations. Furthermore, agencies within the protective services community are using different methods and terminology, which has led to variations and inconsistencies, and the resulting difficulties with interoperability of protective service teams, in the planning and execution of protective operations.

The activities involved in the protection of VIPs are manually intensive and involve a large amount of documents and planning. The information used in the protection of VIPs typically is recorded on documents, spreadsheets and handwritten notes that are then complied into a paper file. Moreover, when staff turns over or someone leaves the agency, the knowledge gained from previous operations may be lost with the person leaving or not readily available for others to access.

There is a need in the art, therefore, for methods and systems that provide protection operation services and procedures that are customizable with respect to the size of the entity that provides the protective services. There is a further need in the art for methods and systems that assist protective teams in planning, detailing, and organizing protective operations to produce consistent results and to enable interoperability of protective services teams provided by different entities.

As the scope, scale, and number of agencies responsible for protection continues to expand, the need for consistency and interoperability has become essential.

### SUMMARY OF THE INVENTION

The present invention solves the above-identified needs, and others, by providing a method and system that assist protective teams in their responsibilities of planning, detailing, and organizing protective operations for VIPs, also referred to as Principals. VIPs may include the President, heads of state, heads of different federal agencies, CEOs of corporations, celebrities, and professional athletes, among others. The method and system of the present invention include selecting or entering a profile for a user account, selecting or entering an operation for protecting a VIP, conducting pre-advance for an operation, conducting advance for an operation, generating an operation plan, conducting the operation, and debriefing the operation. The invention provides an easy to use workflow to guide users through the process, capturing relative data and providing a comprehensive set of Operation Guidelines to assist protective agents in their duties. These Operation Guidelines provide the capability for users to follow a standard set of policies and procedures, including checklists, tasks to perform, and facts to consider, among others. The Operation Guidelines are customizable, and provide a means of internal organization and standardization across the community.

Further, the method and system of the present invention allow centralization of the expertise and experiences of various VIP protective personnel and organizations to facilitate the sharing, analysis, and modernization of this information to create a broad best-practices standard for protective operations, and ultimately provide better protection, life safety, and emergency response for both VIPs and their protectors.

In addition, the method and system of the present invention provide a high degree of collaboration and interactivity. Rather than providing a set of “one size fits all” templates, the present invention permits agencies to modify templates and share their modifications within the agency, or with other users of the system of the present invention. In addition, the method and system of the present invention provide ratings and feedback mechanisms to ensure that system content is of a high quality and is constantly improving with use.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

For a more complete understanding of the present invention, the needs satisfied thereby, and the objects, features, and advantages thereof, reference now is made to the following description taken in connection with the accompanying drawings.

FIG. 1 illustrates a block diagram of various computer system components in accordance with an aspect of the present invention;

FIG. 2 is a block diagram of various exemplary system components, in accordance with an aspect of the present invention;

FIG. 3 presents an example flow diagram of functions performed in accordance with aspects of the present invention;

FIG. 4 is an example of a user's profile in accordance with aspects of the present invention;

FIG. 5 is an example of an agent profile in accordance with aspects of the present invention;

FIG. 6 is an example of an agency profile in accordance with aspects of the present invention;

FIG. 7 is an example of an operations list in accordance with aspects of the present invention;

FIG. 8 is an example of operation information in accordance with aspects of the present invention;

FIG. 9 is an example of pre-advance in accordance with aspects of the present invention;

FIG. 10 is an example of an advance overview in accordance with aspects of the present invention;

FIG. 11 is an example of an airport advance in accordance with aspects of the present invention;

FIG. 12 is an example of an airport advance in accordance with aspects of the present invention;

FIG. 13 is an example of a motorcade advance in accordance with aspects of the present invention;

FIG. 14 is an example of a motorcade advance in accordance with aspects of the present invention;

FIG. 15 is an example of a law enforcement contact advance in accordance with aspects of the present invention;

FIG. 16 is an example of an operation plan in accordance with aspects of the present invention;

FIG. 17 is an example of a resource page in accordance with aspects of the present invention; and

FIG. 18 an example of an post-operation overview in accordance with aspects of the present invention.

### DETAILED DESCRIPTION

Aspects of the present invention and their features and advantages may be understood by referring to the accompanying drawings, like numerals being used for like corresponding parts in the various drawings.

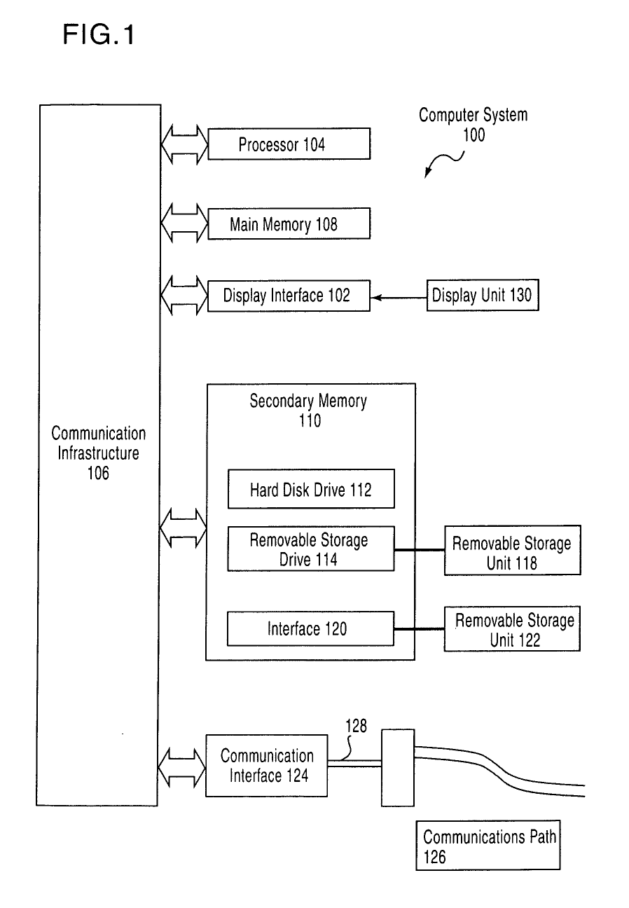

The present invention may be implemented using hardware, software, or a combination thereof and may be implemented in one or more computer systems or other processing systems. In an aspect of the present invention, the invention is directed toward one or more computer systems capable of carrying out the functionality described herein. An example of such a computer system 100 is shown in FIG. 1.

Computer system 100 includes one or more processors, such as processor 104. The processor 104 is connected to a communication infrastructure 106 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 100 can include a display interface 102 that forwards graphics, text, and other data from the communication infrastructure 106 (or from a frame buffer not shown) for display on a display unit 130. Computer system 100 also includes a main memory 108, preferably random access memory (RAM), and may also include a secondary memory 110. The secondary memory 110 may include, for example, a hard disk drive 112 and/or a removable storage drive 114, representing a floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc., which is read by and written to removable storage drive 114. As will be appreciated, the removable storage unit 118 includes a computer usable storage medium having stored therein computer software and/or data.

Alternative aspects of the present invention may include secondary memory 110 and may include other similar devices for allowing computer programs or other instructions to be loaded into computer system 100. Such devices may include, for example, a removable storage unit 122 and an interface 120. Examples of such may include a program cartridge and cartridge interface (such as that found in video game devices), a removable memory chip (such as an erasable programmable read only memory (EPROM), or programmable read only memory (PROM)) and associated socket, and other removable storage units 122 and interfaces 120, which allow software and data to be transferred from the removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128, which may be electronic, electromagnetic, optical or other signals capable of being received by communications interface 124. These signals 128 are provided to communications interface 124 via a communications path (e.g., channel) 126. This path 126 carries signals 128 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 180, a hard disk installed in hard disk drive 170, and signals 128. These computer program products provide software to the computer system 100. The invention is directed to such computer program products.

Computer programs (also referred to as computer control logic) are stored in main memory 108 and/or secondary memory 110. Computer programs may also be received via communications interface 124. Such computer programs, when executed, enable the computer system 100 to perform the features of the present invention, as discussed herein. In particular, the computer programs, when executed, enable the processor 110 to perform the features of the present invention. Accordingly, such computer programs represent controllers of the computer system 100.

In an aspect of the present invention where the invention is implemented using software, the software may be stored in a computer program product and loaded into computer system 100 using removable storage drive 114, hard drive 112, or communications interface 120. The control logic (software), when executed by the processor 104, causes the processor 104 to perform the functions of the invention as described herein. In another aspect of the present invention, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

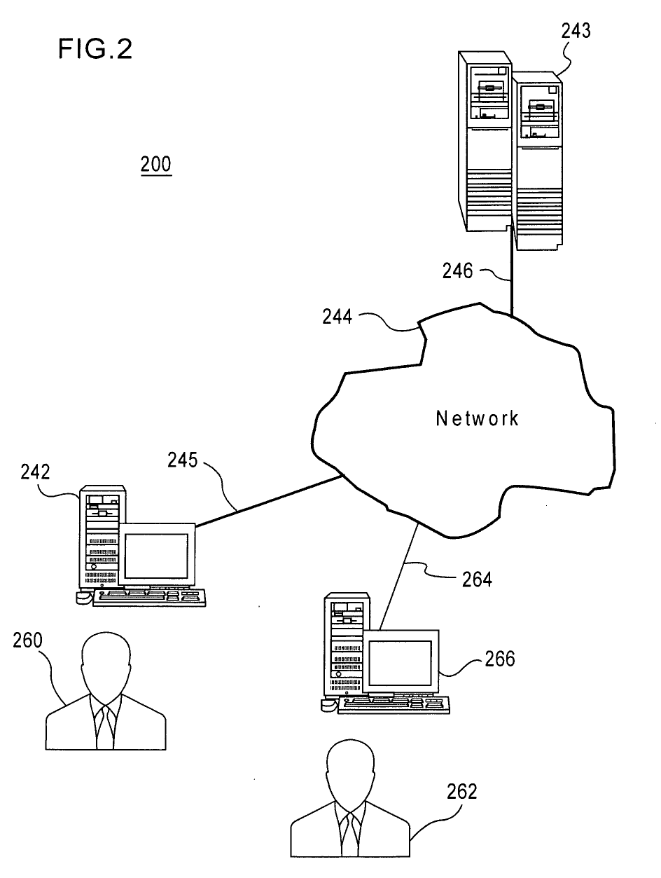

FIG. 2 shows a communication system 200 usable in accordance with the present invention. The communication system 200 includes one or more accessors 260, 262 (also referred to interchangeably herein as one or more “users”) and one or more terminals 242, 266. In one aspect of the present invention, data for use is, for example, input and/or accessed by accessors 260, 264 via terminals 242, 266, such as personal computers (PCs), minicomputers, mainframe computers, microcomputers, telephonic devices, or wireless devices, such as personal digital assistants (“PDAs”) or a hand-held wireless devices coupled to a server 243, such as a PC, minicomputer, mainframe computer, microcomputer, or other device having a processor and a repository for data and/or connection to a repository for data, via, for example, a network 244, such as the Internet or an intranet, and couplings 245, 246, 264. The couplings 245, 246, 264 include, for example, wired, wireless, or fiberoptic links. In another aspect of the present invention, the method and system of the present invention operate in a stand-alone environment, such as on a single terminal.

The present invention may be implemented as an interactive workflow wizard, which assists users through the various steps of the operation planning process, in accordance with an aspect of the present invention.

Further, the system may be provided as an integrated product via the use of an installation wizard, which can automatically guide a user through the process of installing the system components, including a server and database instance, if necessary, and the actual system application onto a designated environment, and facilitate the correct configuration of these components for proper system operations.

In accordance with another aspect of the present invention, the system may be deployed, e.g., to run in a standalone environment. Alternatively, in accordance with another aspect of the present invention, the system may also be customized to be compatible with other networks, such as secure networks used by government and/or private entities.

Moreover, given the sensitive nature of the content that can be saved into the system, security of the content is of primary importance. For example, internal system security may be provided via the different user account roles within the system, and the various access rights that each user account type is assigned. Exemplary user types are described in more detail below. The user account roles may limit access to information that can be viewed, modified, and searched by requiring explicit access approval issued to a user by an administrator of the system.

In addition, an aspect of the present invention involves sharing of sensitive information between different agencies using the system, e.g., via a model “hidden by default, and shareable as necessary.” For example, Agency X's information within the system may remain hidden from view and inaccessible for search to other agencies using the system, until Agency X explicitly decides to share specific information with the system community. In addition, Agency X may choose to share its, e.g., proprietary customized Hotel Operation Guideline, at one or more levels. For example, at one level, Agency X may provide information that it has a customized Hotel Guideline, without actually disclosing the contents of the guideline. Alternatively, Agency X may share portions or the entire customized Hotel Guideline for others to search and/or view.

In accordance with an aspect of the present invention, the system software may be deployed to a secure environment, which provides internal authorization and authentication services, and a consistent and standard means of managing security.

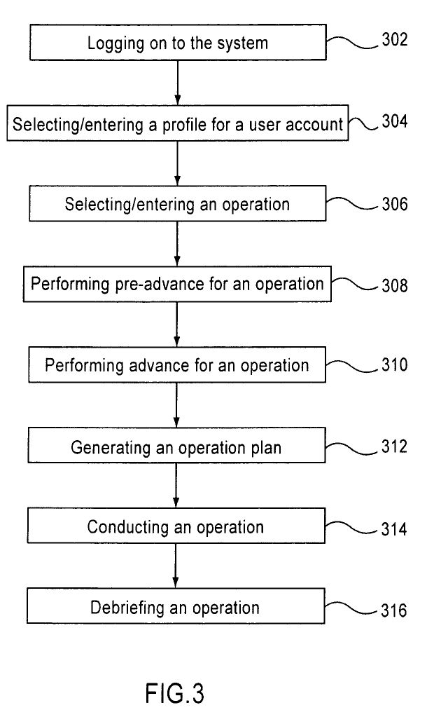

An example flow diagram 300 of functions performed in accordance with an aspect of the present invention will now be described in conjunction with FIG. 3.

After a user logs onto the system 302, the user can select a preexisting profile for the user's account or enter a new profile for a user account 304. Internal system security may be provided via the different user account roles within the system, and the various access rights that each user account type may be assigned. Next, a user selects an operation previously in the system, or enters an operation 306. Once an operation is selected, pre-advance is conducted for the operation 308. Pre-advance may identify various items of information the user wants to capture regarding the operation. Next, advance is performed for the operation 310. During the advance stage, the information for the operation may be captured by visiting the various sites and/or researching the places involved in the operation. After the items of information for an operation are captured, an operation plan may be generated based on the information captured 312. Next, the operation is conducted 314. Once an operation is completed, debriefing may be performed 316 to discuss the operation, write any reports that may be necessary and to discuss any lessons learned, among other debriefing operations.

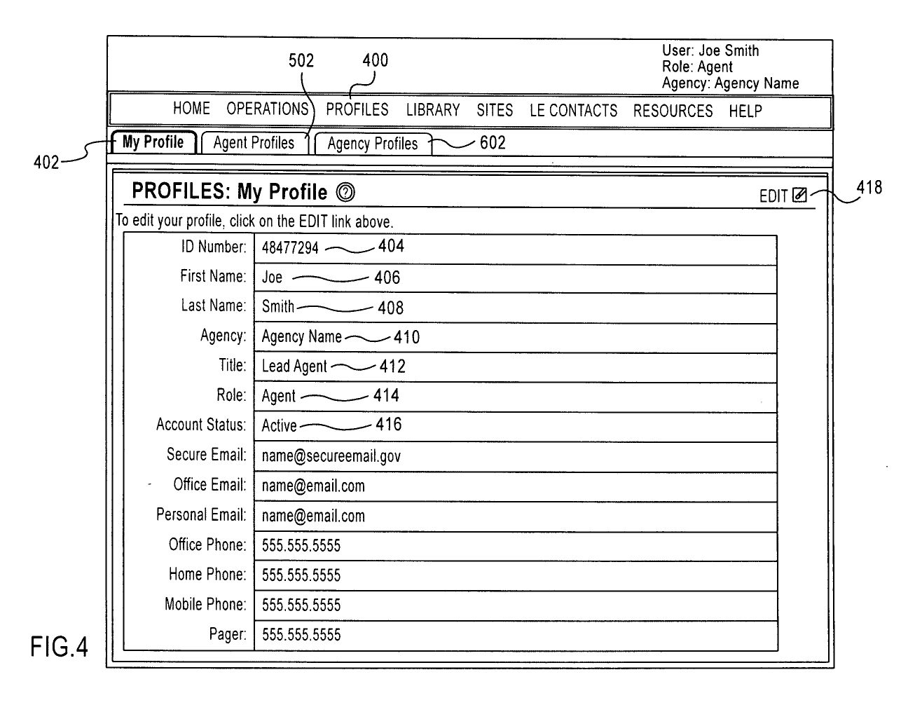

The process of a user selecting, or entering, a profile in accordance with an aspect of the present invention, is presented in more detail in FIGS. 4-6. In the same manner that a security team (interchangeably referred to herein as a detail) has various members with different responsibilities, the system may also require different users, each with unique rights within the system. The user accounts may conform to any requirements within the operational deployment environment. In an aspect of the present invention, it is assumed that the system will be installed on a secure network, which requires each user, no matter their role, to possess a secure network account, thus providing an extra layer of authentication. Nonetheless, all or some of the granular details regarding the access levels of each user may be managed within the system itself.

As illustrated in FIG. 4, a user may have access to the System's profile section after selecting PROFILES tab 400. After selecting PROFILES tab 400, the user may have access to the user's personal profile 402, other agent's profiles 502, or various agencies profiles 602, among others, depending on what type of access rights the user may have to the system. Each user of the system may be assigned an identification number 404. This identification number 404 is unique to the individual and may be used to identify the user to the system. The user's first name 406, last name 408 and the agency 410 the user belongs to may be displayed in the user's profile section. In addition, the user's title 412, role 414 and account status 416 may be displayed under the user's profile, among other information.

In accordance with an aspect of the present invention, a user's title may include lead agent or agent, for example, depending on what position the user has been assigned on this particular operation. An agent may be a person who is assigned to work in an operation's detail team. It should be appreciated that an agent may be the user or another individual who is working on a detail team of an operation. Further, a user's title may vary based upon which operation is selected. For example, a user may be an agent in one operation, while being a lead agent in a different operation. In addition, a user's account status 416 may be active or inactive. If the account status 416 is inactive, then the user is no longer able to access the system. Moreover, various contact information for the user may be provided in the profile section. For example, a user's office telephone number, home telephone number, e-mail addresses, pager, or other contact information may be provided. It should be appreciated that a user may edit the information provided in the profile section by selecting the edit icon 418.

In addition, in accordance with aspects of the present invention, a user may have various user roles 414 which may include, among others, an agent, an agency administrator, or a system administrator. Furthermore, security access to the system may be provided via the different user roles within the system as well as the various access rights that each user is assigned. For example, a user who is an agent may be able to view and edit the user's own profile and may be able to see information regarding the user's agency or the operation the user is currently working on. However, a user who is an agent may not be able to see other user's information or have the ability to edit other user's information. A user who is an agency administrator may be able to add or edit profiles of other users using the administrator's agency system, grant various access rights to the different users, provide rights as read-only or read/write permission in accordance with various guidelines, while protecting other details of the operation, such as the entire operation itinerary, and open and close an operation, among other access rights. Furthermore, a user who is a system administrator may have the ability to add or edit the users of any agency that uses the system, and to add or edit any agency in the system.

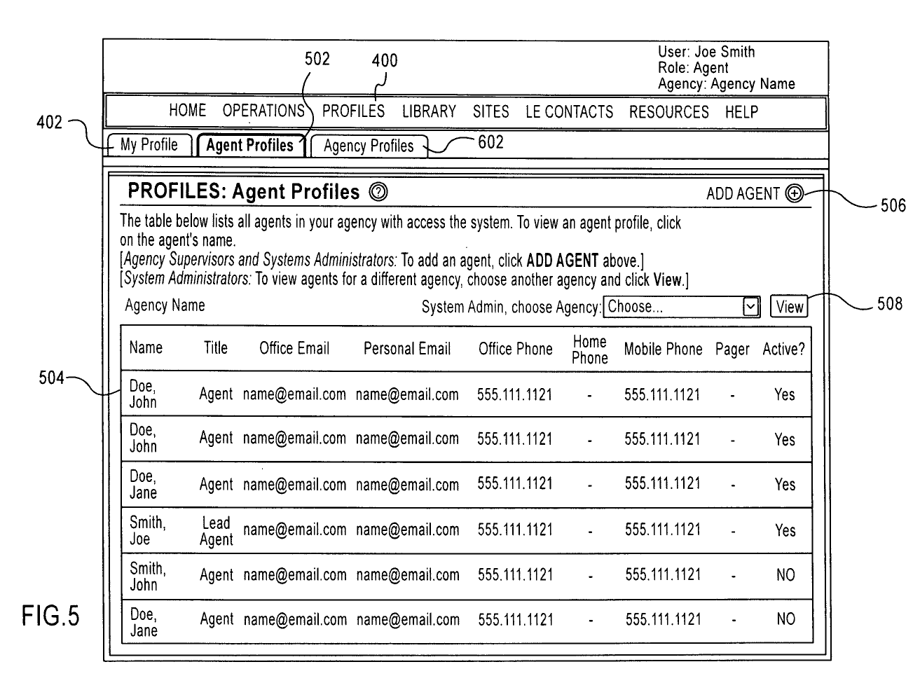

FIG. 5 illustrates an exemplary graphic user interface (GUI) screen showing various agents' profiles, according to an aspect of the present invention. If the user has security access, as discussed above, to view other agent's profiles, the user may select the Agent Profiles tab 502 to view a list 504 of other agents' names. List 504 may provide the names of the agents in the user's agency that have access to the system, among others. In accordance with one aspect, list 504 may include the agent's name, title, contact information, and whether the agent's account is active, among other information. Moreover, depending on the user's role, or security access, the user may be able to add an agent 506 or view agents from a different agency 508.

According to aspects of the present invention, when adding an agent to a particular agency, the user may first search the system for the agent's user account. The system may require that an agent have a valid user account before a system administrator adds an agent to the system. The user may search by first name, last name or e-mail address of the agent, for example. A listing of system accounts matching the search criteria may be provided. Once a system account is selected, the user may add or update the agent's information. For example, the user may input the agent's title and role for this agency or operation, among other information.

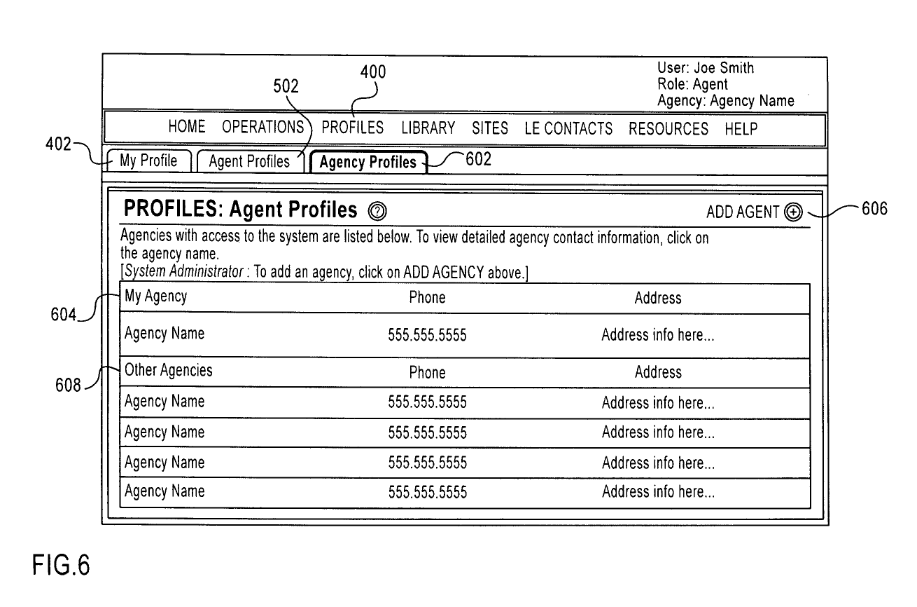

Additionally, various agency profiles may be listed in accordance with an aspect of the present invention, as illustrated in FIG. 6. If the user has security access to view agency profiles, the user may select the Agency Profiles tab 602 to display an agency list. This agency list may be split into several portions which may include, among other items, a list of the user's agencies 604 and a list of other agencies 608, to which the user may not belong. It should be appreciated that a user may be able to view one, or both, of these list of agencies depending on the user's security access to the system. Furthermore, the user may be able to add an agency by selecting the add agency icon 606. This would allow the user to add an agency's name, address, phone number, fax number, and primary and/or secondary contact information for individuals at the agency, for example.

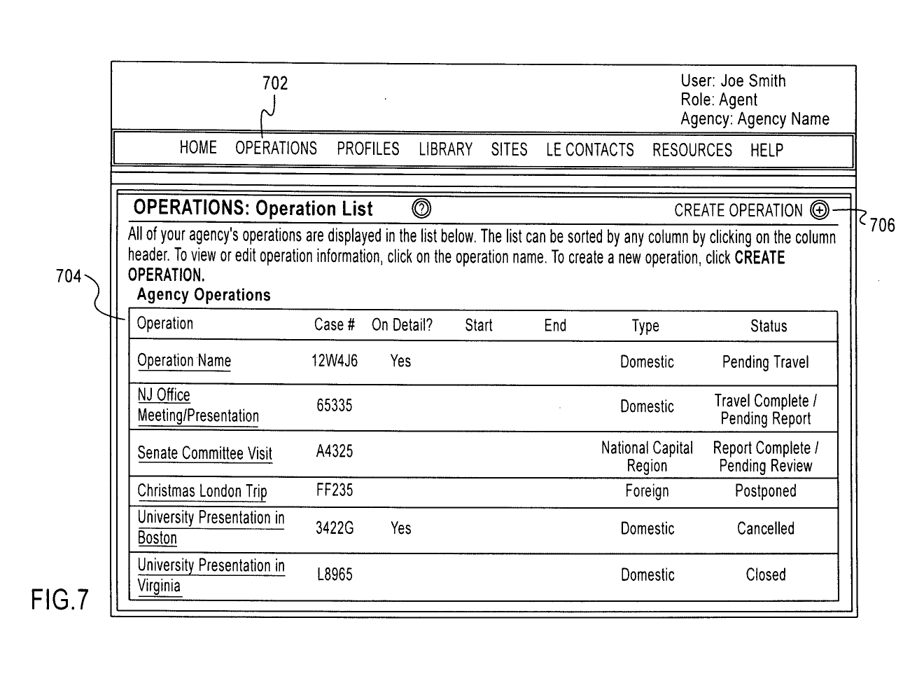

According to an aspect of the present invention, the user may have access to an operations listed for the user's agency by selecting the OPERATIONS tab 702, as illustrated in FIG. 7. After selecting the OPERATIONS tab 702, the user may see a list of agency operations 704. The list of agency operations 704 may include an operation's name, case number, whether the user is on detail for the particular operation, the start and end date of the operation, the type of operation, and the status of an operation, among other information. Each operation may be assigned a unique case number. This case number may be used in searching for existing operations, aiding the user in identifying an operation, and used in classifying information relating to the operation, among others.

Further, the type of operation may include various areas where an operation may take place. For example, an operation may take place domestically, in a foreign location, or in the national capital region, among other locations. Further, the status of an operation may be pending travel, travel completed/pending report, report completed/pending review, postponed, cancelled, or closed, among others. In accordance with an aspect of the present invention, various operations listed may have the same status and type as other operations listed. Moreover, it should be appreciated that an agent may be assigned to more than one operation or to none of the operations listed. In addition, the user may have security access to create an operation by selecting the create operation icon 706. The user may input an operation's name, start and end date, type of operation, status of the operation, a case number, information regarding the mission of the operation, and notes on the operation, among other information.

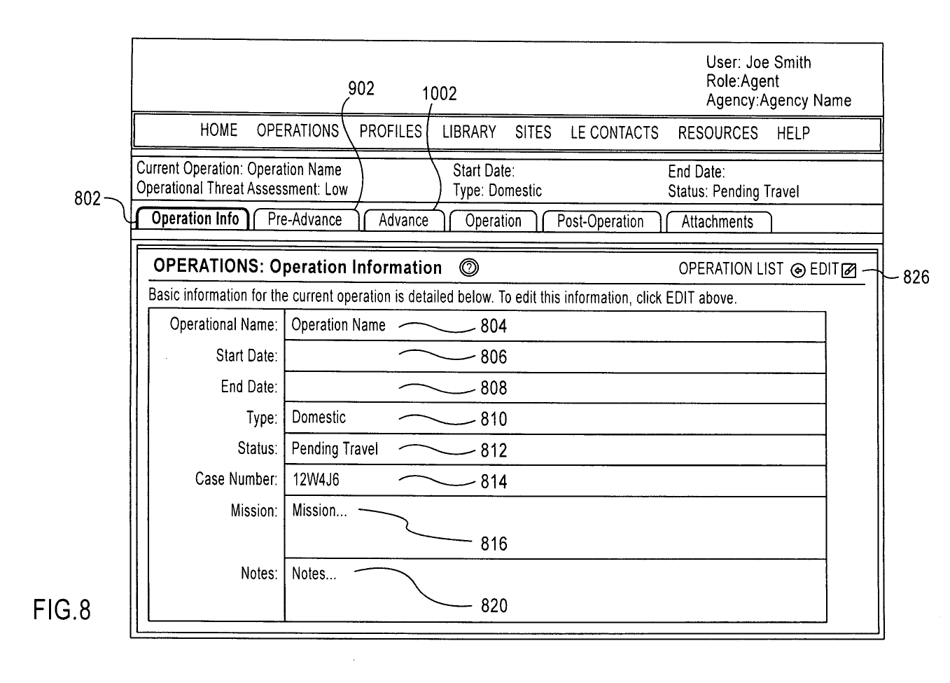

In accordance with an aspect of the present invention, once the user selects a particular operation from the list of agency operations 704, the operation information 802 pertaining to the selected operation may be displayed, as illustrated in FIG. 8. The information displayed may include the operation name 804, start date 806, end date 808, type of operation 810, status 812, case number 814, mission of an operation 816, or any notes 820 for the operation, among others. It should be appreciated that the type of operation 810 may include various areas where the operation may take place. For example, the operation may take place domestically, in a foreign location, or in the national capital region, among other locations. Further, the status 812 of an operation may be pending travel, travel completed/pending report, report completed/pending review, postponed, cancelled, or closed, among others.

Further, in accordance with aspects of the present invention the user may have the ability to edit the information displayed for the operation by selecting the edit icon 826. Additionally, the user may be able to navigate back to the list of agency operations 704 by selecting the operation list icon 824.

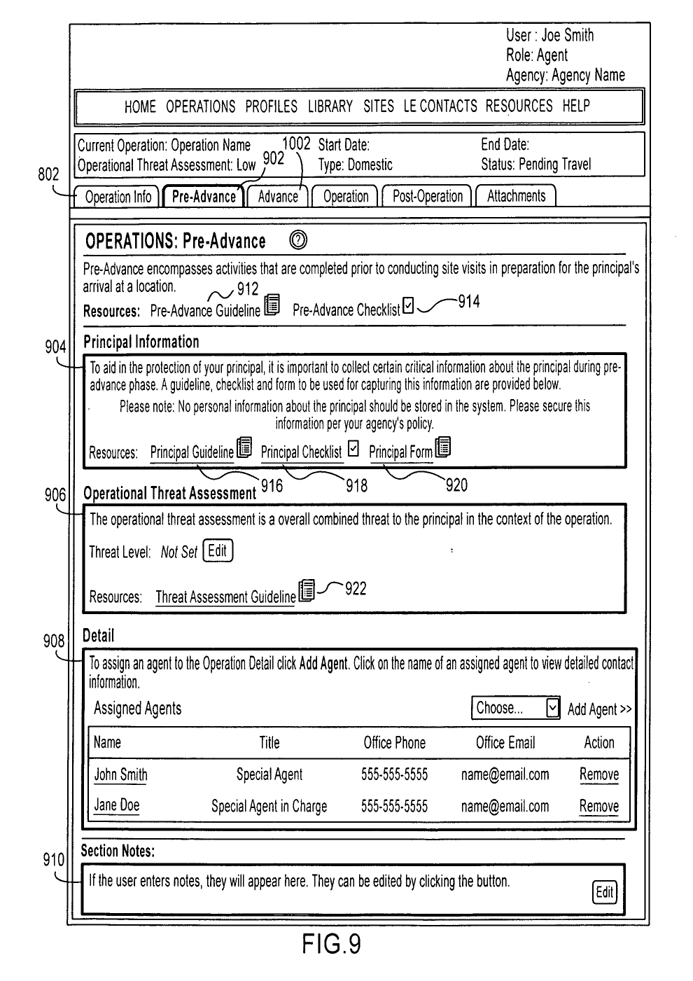

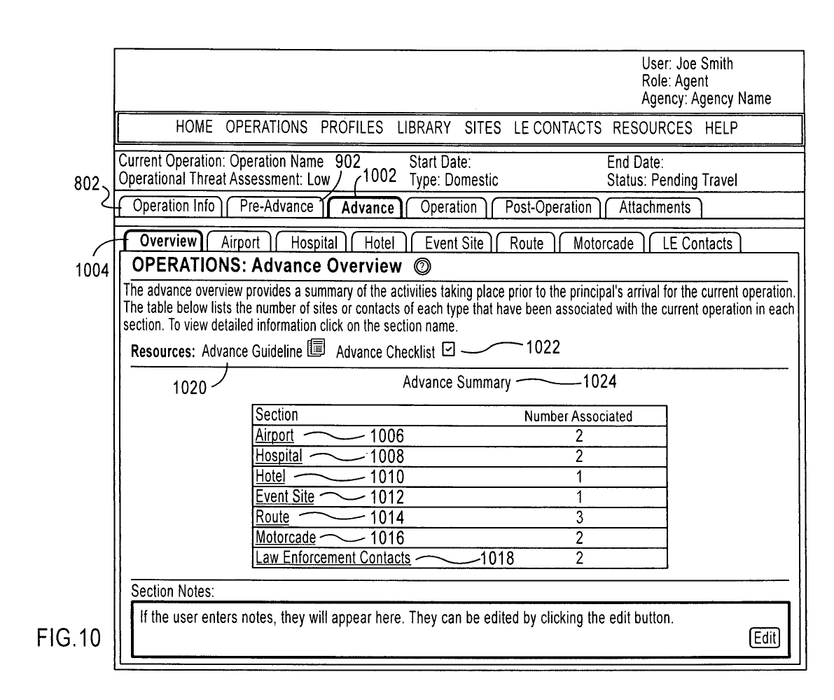

After an operation is selected, in accordance with an aspect of the present invention, pre-advance is conducted for the selected operation, as illustrated in FIG. 9. The planning of any protective operation may begin with pre-advance, which serves as the foundation and blueprint for any protective operation. Pre-advance may include identifying items of information relating to the operation. The operation information items identified may include, among others, principal information 904, operational threat level 906, operation detail information 908, notes about the operation 910, route information, mode of transportation, operation itineraries, medical and safety requirements, lodging requirements, and other details that may affect the trip and the stay of a VIP.

Additionally, a user may have access to resource material which may aid the user in conducting pre-advance. The resources may include, for example, pre-advance guidelines 912 and pre-advance checklists 914 which may provide guidance regarding the steps involved in pre-advance and the information that may be identified for an operation. These guidelines, as with other guidelines, may require of the protection team to compile numerous details. Most of this information can be gathered before leaving the office, e.g., via a phone and/or a computer. Another important aspect of these guidelines is that they may answer the question “Now what”? In other words, once the Detail Leader, also referred to as a lead agent, has been informed of the basic information regarding the trip, the appropriate guidelines may provide guidance to the detail team to collect a range of information, follow standard procedures, go through a choice of checklists, collect an assortment of equipment, and complete various other tasks. To completely fulfill the requirements of the guidelines, the advance team will most likely need to step away from the office and go out to the field.

The principal information 904 identified during pre-advance should identify critical information necessary to protect the VIP. For example, this information may include identifying the VIP and/or the VIP's assistants, and/or any medical or safety requirements for the VIP. To aid the user in identifying the critical information necessary to protect the VIP, the user may be provided with access to e.g., a principal guideline 916, a principal checklist 918 and a principal form 920. These resources may provide guidance as to what personal and medical information the user may want to acquire about the principal. For example, the user may want to know the VIP's age, blood type, any medical conditions the VIP may have, and emergency contacts, among other information.

In accordance with an aspect of the present invention, the operational threat level 906 may be identified, which may allow the detail leader to make appropriate decisions regarding the resources needed for the trip, including whether the trip itinerary needs to be modified. The goal of identifying the threat level is to identify the threats to be avoided, which can include serious threats, from assorted violence or medical emergencies, to less serious risks such as injury or embarrassment of the Principal, which can derail the objectives of the Principal's trip (e.g., a Principal visiting European Union officials in Brussels, Belgium being struck in the face with a pie when entering a government building to give a speech on education). Additionally, the agents involved in the operation may have access to a threat assessment guideline 922 to guide the user in identifying possible threats to the operation.

To facilitate the Detail Leader in conducting risk assessment resources may be made available by the system, including a calendar feature, which may provide critical data regarding possible heightened risk of operation dates, real-time news and events feed, and various links to other information. These may include contact information for the U.S. Embassy at the destination, information from previous operations at the same destination, overseas security advisory counsel, U.S. State Department Travel advisories, system calendar, real-time news and events feeds, or other links as defined and noted by Subject Matter Experts and the Protective Services Community. In accordance with aspects of the present invention, the threat assessment process may be continuously re-administered throughout the life of the operation, allowing the team of agents to modify the operation details as necessary.

In addition, the operation detail information 908 may be identified during pre-advance. The operation detail information 908 may include identifying the agents assigned to the operation, along with the agents' profiles and medical information, among other information. If the user has any comments regarding the operation, the user may write the comments in notes section 910. In accordance with aspects of the present invention, for each operation, the information identified during pre-advance may be customized for that particular operation or may include information relating to another operation.

After the pre-advance stage of the operation is completed, advance is conducted for the operation, as illustrated in FIGS. 10-15, in accordance with aspects of the present invention. Advance may be used to capture information relating to the operation and to collect intelligence, as identified in the guidelines. This information may include, for example, taking photographs and uploading them as attachments to the system, traversing routes to identify choke points and safe havens, coordinating with various local, county and/or state law enforcement agents, airport or hotel staff (as necessary, if not accomplished via phone), gather all needed resources for the operation, and update the threat assessment of the operation, among other tasks. During this stage of the operation, agents may visit the sites identified during pre-advance, and/or perform research to gather necessary information. During advance, the users that have been given access rights to various guidelines may begin customizing the tasks, checklists, equipment listings, and other requirements posed by the guidelines based on the specific needs of the operation.

Referring to FIG. 10, the user can select the Overview tab 1004 to receive an advance overview of the operation displayed. The advance overview of the operation may provide a summary 1024 of the activities taking place prior to the VIPs arrival for the current operation. The user may have access to advance guidelines 1020 or advance checklist 1022 to guide the user in performing the advance stage of the operation. The guidelines may provide fact sheets, Best Practices, checklist, equipment and attachment listings, guidelines to assist with organizing operations details and creating standardization in operation planning and execution, and may provide reminders to users, among other information. In summary, the guidelines may provide the detail team a simplified and standardized way to plan and organize operations. The guidelines may provide a mechanism for customization of tasks, checklists, and other requirements, and may assist the Detail Leader in appropriately managing the details of the operation. This is important since insignificant oversights in details may create inconveniences during the operation, which can easily be magnified in scope under the tight schedules and less controllable environments connected with most operations.

It should be appreciated that some of the recommend guidelines are not applicable for the scope of every operation. Thus, the detail leader can decide which recommended guidelines are applicable to the operation and may mark the guidelines that are not applicable to the operation as not relevant. In accordance with aspects of the present invention, a system reminder service may be used to remind the detail leader of uncompleted guidelines or tasks that still need to be completed.

The advance summary 1024 may include the number of sites or contacts of each type that have been associated with the current operation. For example the summary may list the airports 1006, hospitals 1008, hotels 1010, event sites 1012, routes 1014, motorcade information 1016, and law enforcement contacts 1018, among other information, that might be associated with the current operation. It should be appreciated that more than one site or contact may be associated with an operation. For example, there may be two airports, two hospitals, three different routes, two motorcades, and/or two law enforcement contacts, among others.

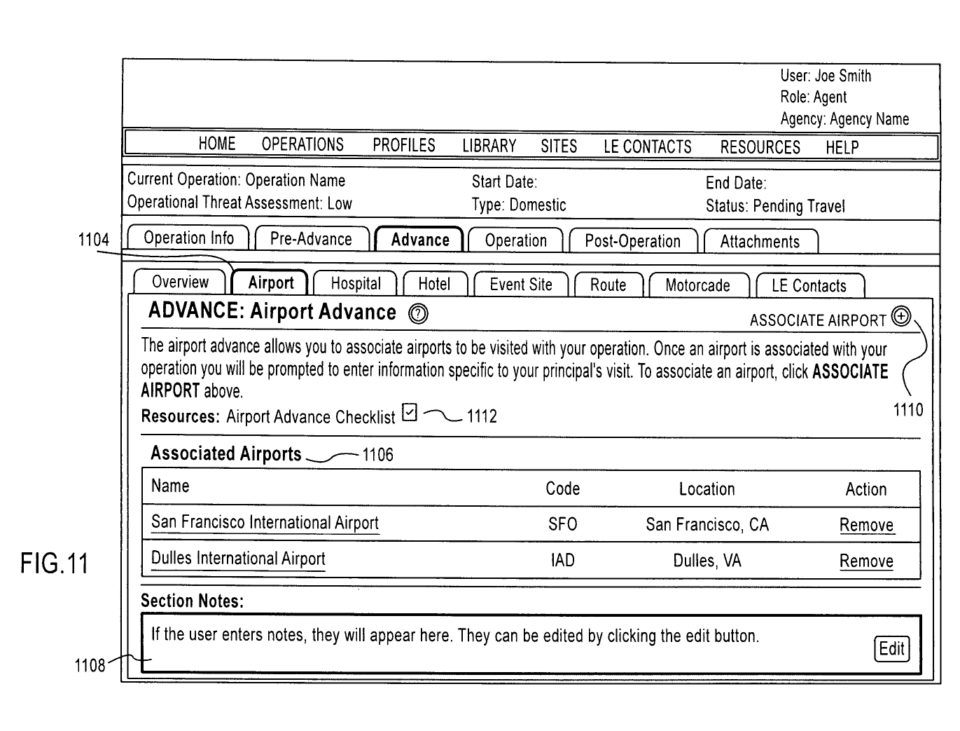

As illustrated in FIG. 11, in accordance with an aspect of the present invention, a user may select the airport tab 1104 to see a list of the associated airports 1106 for a current operation. It should be appreciated that there may be no airports associated with an operation, one airport, or multiple airports. The user may be able to select a particular airport and view information regarding that airport. This information may include the airport name, contact information, hours of operation, cell phone signal strength, time zone, a website for the airport, highest floors reachable by the fire department, closest safe haven, route to the closest safe haven, closest hospital, route to the closest hospital, number to dial for an outside line, physical description of the airport, security information, on site medical information, site facility information, number of restrooms, number of floors, fire alarm pulls locations, entrances and exits, and the VIP's arrival and departure information, among others.

Further, the user may be able to associate an airport with an operation by selecting the associate airport icon 1110. Additionally, it should be appreciated that a user may be able to add an airport to the operation, cancel an airport's association with the operation, search for an airport within the system, and view a list of airports used in previous operations in the same area, among other operations.

In addition, the user may have access to an airport advance checklist 1112. As discussed above in relation to the other stages of an operation, the checklist may provide guidelines as to what information may be important to the user regarding the airport. If the user has any comments regarding the advance on the airports, the user can enter them into the section notes 1108.

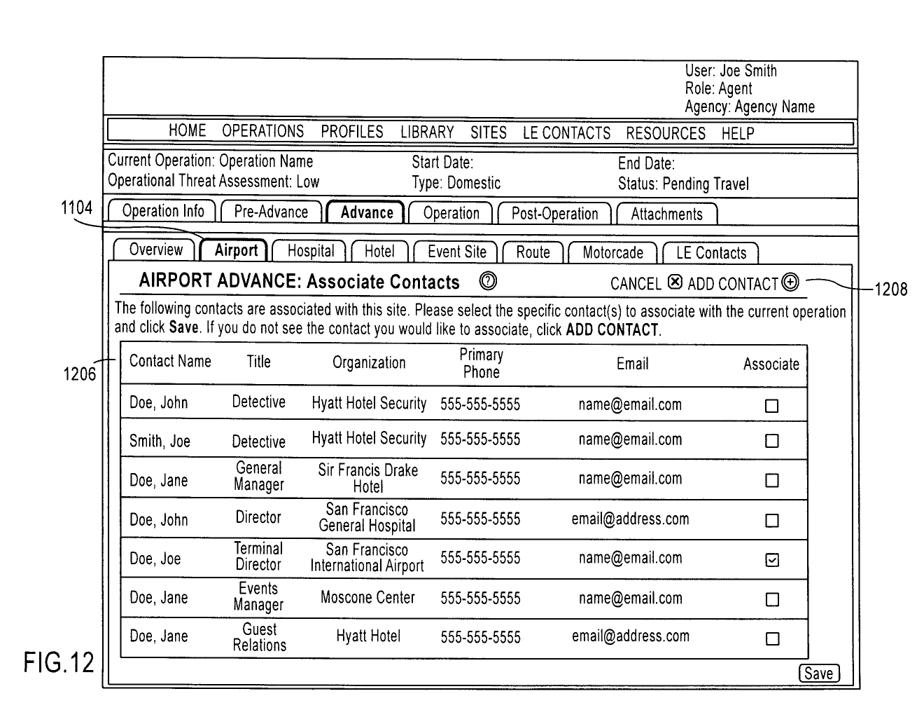

Moreover, in accordance with an aspect of the present invention, the user can see a list of potential associate contacts 1206 to be associated with the particular airport, as illustrated in FIG. 12. The list of associate contacts 1206 may include the associate contact's name, title, organization, primary telephone, e-mail address and whether the associate is connected with the operation, among other information. It should be appreciated that the user may be able to edit or add a contact 1208 for a particular site. This may involve adding the contact's name, title, organization, primary telephone, secondary telephone, e-mail address and any notes the user may wish to provide for the contact, among other information.

In accordance with aspects of the present invention, the user may be able to perform functionality, that is similar to the functionality discussed above in connection with the airport, with respect to any other sites or contacts associated with an operation. For example, such sites/contacts may include hotels, other lodging venues, hospitals, event sites, routes, motorcades or law enforcement contacts, among others. In accordance with aspects of the present invention, the functionality may be tailored for a particular site or contact. For example, the route information the user has access to may include the starting point, ending point, directions, alternative directions, alternative routes, potential choke points, nearest hospitals along the route, closest safe heavens, travel distance, and notes regarding the route, among other information.

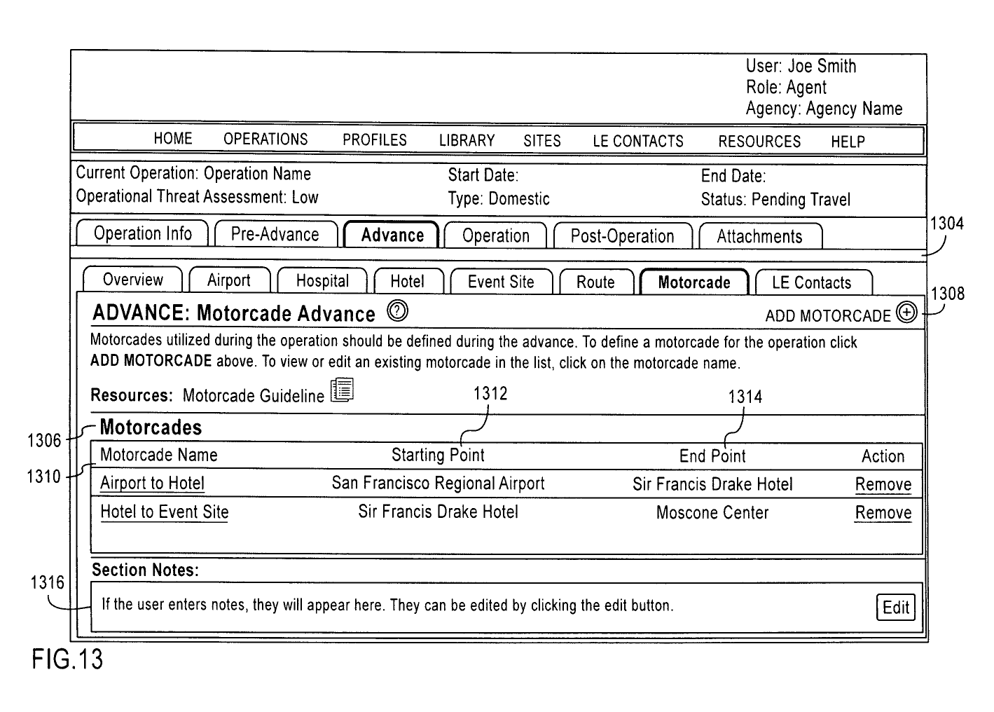

Additionally, in accordance with an aspect of the present invention, the user may have access to motorcade information, as illustrated in FIG. 13. The user may select the Motorcade tab 1304 to view a motorcade list 1306 of the various motorcades associated with the operation. It should be appreciated that there can be any number of motorcades associated with an operation. Further, a motorcade may not be necessary for every operation. The user may have access to the motorcade name 1310, the starting point 1312, the end point 1314, and any notes 1316 involving the motorcade, among other information. In addition, the user may add a motorcade 1308 or edit the existing motorcade information.

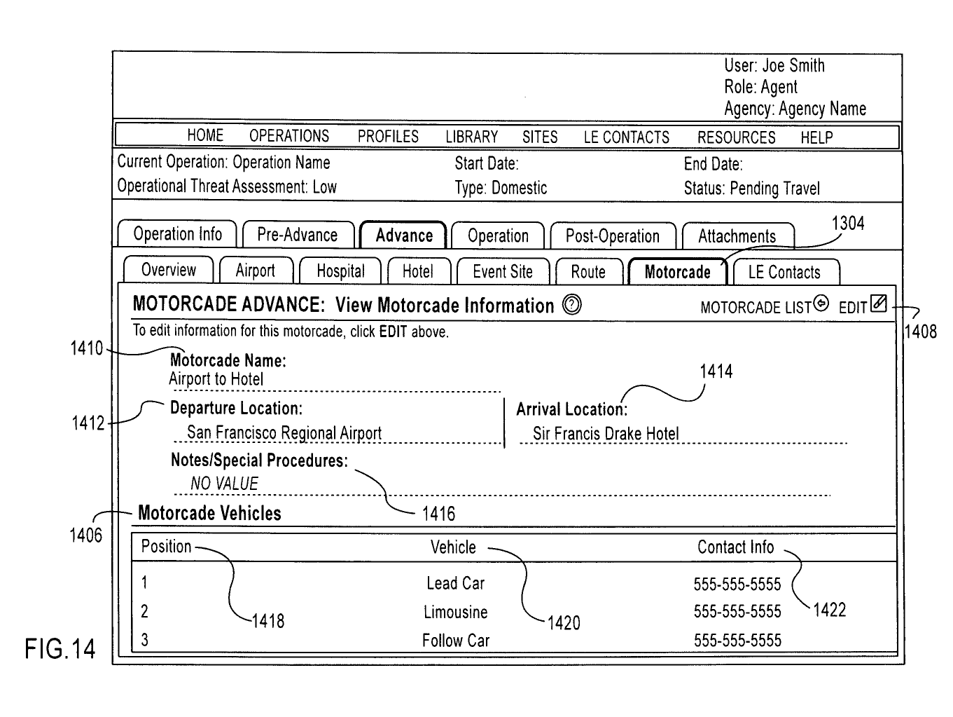

By selecting a motorcade from the motorcade list 1306, the user may be able to view the information for a particular motorcade, as illustrated in FIG. 14. The user may be able to view the motorcade name 1410, departure location 1412, arrival location 1414, any notes or special procedures regarding the motorcade 1416, a list of motorcade vehicles 1406, the position 1418 vehicle 1420 is in the motorcade, contact information 1422 for vehicle 1420, the license state and number of vehicle 1420 and driver of vehicle 1420, vehicle 1420 make and model, vehicle 1420 color, any passengers in vehicle 1420, whether vehicle 1420 is emergency equipped, and any responsibilities that may be associated with vehicle 1420, among other information. In addition, the user may edit the motorcade information by selecting the edit icon 1408.

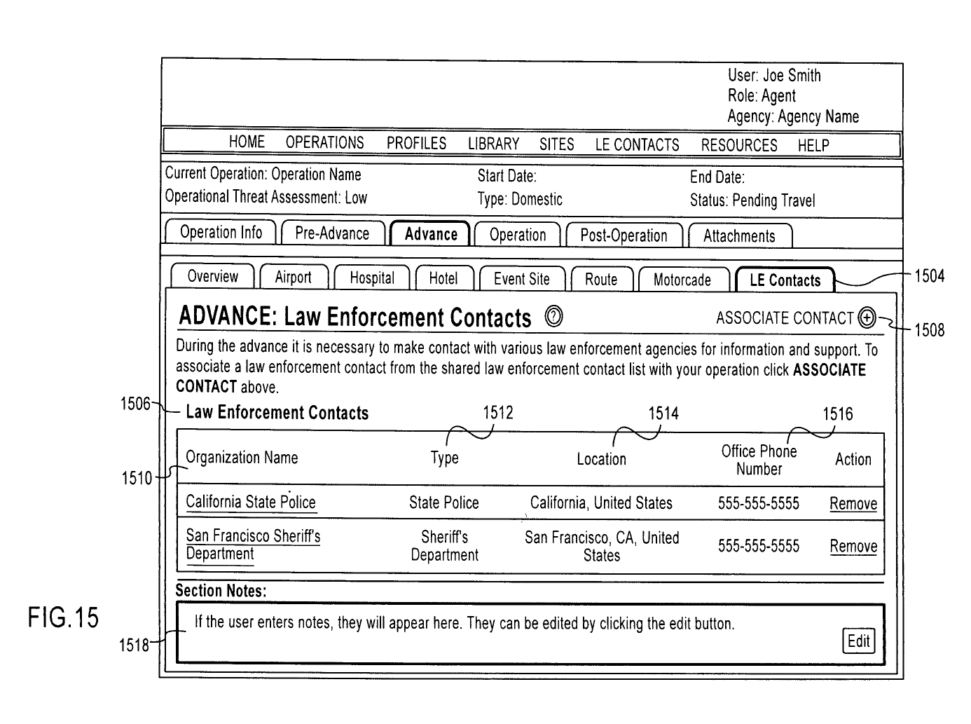

In accordance with an aspect of the present invention, the user may have access to law enforcement contacts associated with the operation, as illustrated in FIG. 15. A list of law enforcement contacts 1506 may be displayed listing the law enforcement contacts that may be associated with an operation. The user may have access to a law enforcement contact's organization name 1510, type of organization 1512, office location 1514, office telephone number 1516, any additional contact information for the law enforcement contact, and notes or comments 1518 regarding the law enforcement contact, among other information. In addition, the user may be able to associate the listed law enforcement contact with the operation by selecting “ASSOCIATE CONTACT” 1508. Further, the user may add, edit, or delete a law enforcement contact associated with the operation.

In accordance with aspects of the present invention, the information gathered during advance is customizable for each operation and may change based upon changes in itinerary, threat assessments, how many VIPs are traveling, traffic, construction, news and events, and modifications in locations of events, among others. Further, these changes may occur before the operation occurs or during the operation.

In accordance with an aspect of the present invention, once the user has appropriately provided the system with various details of the operation, including the itinerary, the system may recommend various other guidelines to be used for the operation. The user may also be able to search and browse all guidelines available in the system, as necessary.

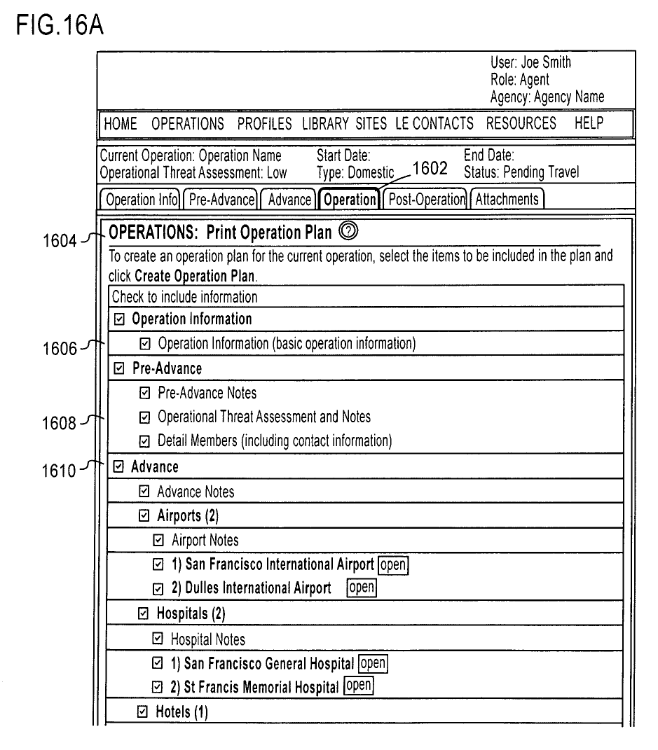

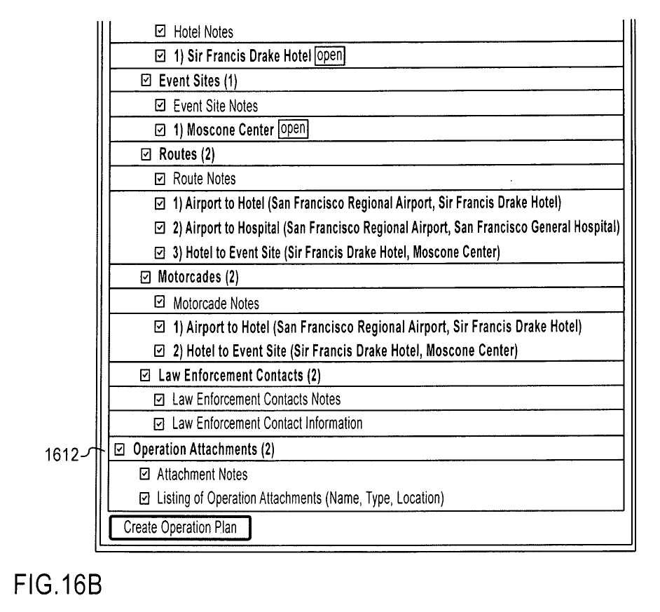

In accordance with an aspect of the present invention, once advance has been completed, including tasks, checklists, and allocation of essential equipment, the necessary planning may be completed, and the assorted details may be defined and documented. As the actual operation begins, the system may be used to further review and modify details. The customized guidelines may provide standard organization of all details, and may be leveraged and referenced in printable format or downloaded in standard file formats (i.e., PDF format) to be leveraged by the protective team, as illustrated in FIG. 16.

The user may print an operation plan 1604 that may list the operation information 1606, any pre-advance 1608 information that was identified and gathered, advance information 1610 that was captured, and any operational attachments 1612, among other information. Operation attachments 1612 may include any maps, diagrams, floor plans, pictures, audio files, video files, documents, spreadsheets, correspondence, or any other information the user may wish to associate with the operation. The system may have a library which contains files that the users have uploaded to the system. The library may provide a centralized location to store information that may be used in the current operation or in future operations.

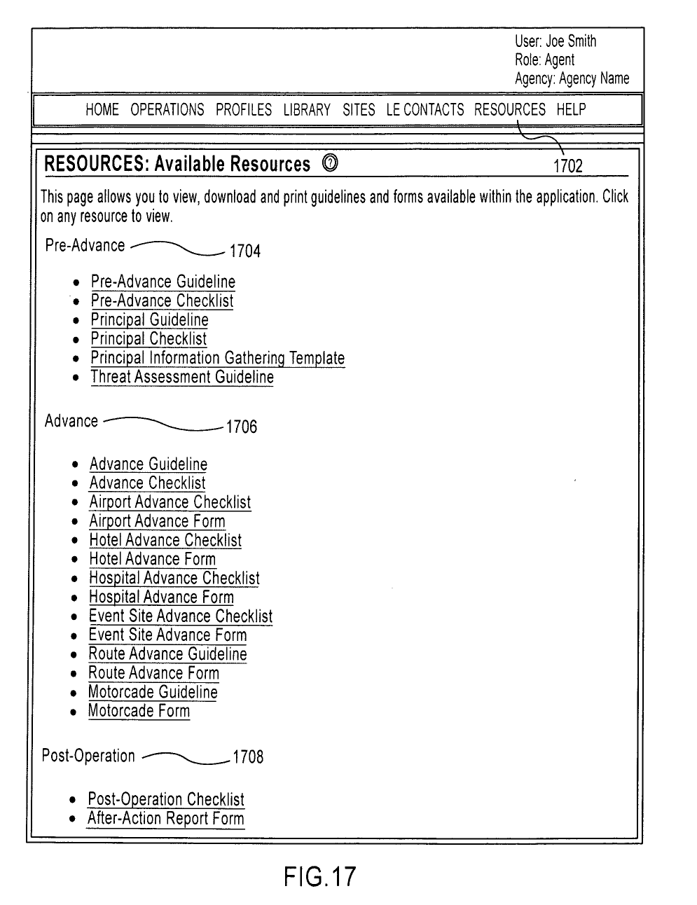

In accordance with aspects of the present invention, the user may search the library, or the entire system, for relevant information regarding the operation. The user may search the system by country, state, or site type to determine whether an operation may have been conducted in the same location or site before. If so, the user may be able to access relevant documents that may have been previously uploaded to the system relating to other operations within the user's agency and/or other agencies. Further, the user may be able to search the system for previously entered law enforcement contacts. In addition, the system may have a resource page listing the available resources for the operation, as illustrated in FIG. 17. The user may access the resource page by selecting the resource tab 1702. The resource page may include pre-advance 1704 guidelines or checklists, advance 1706 guidelines or checklists, and post-operation 1708 checklists and after-action report forms that may be necessary for the operation. The resource page may allow the user to access different guidelines and checklists without having to search for them.

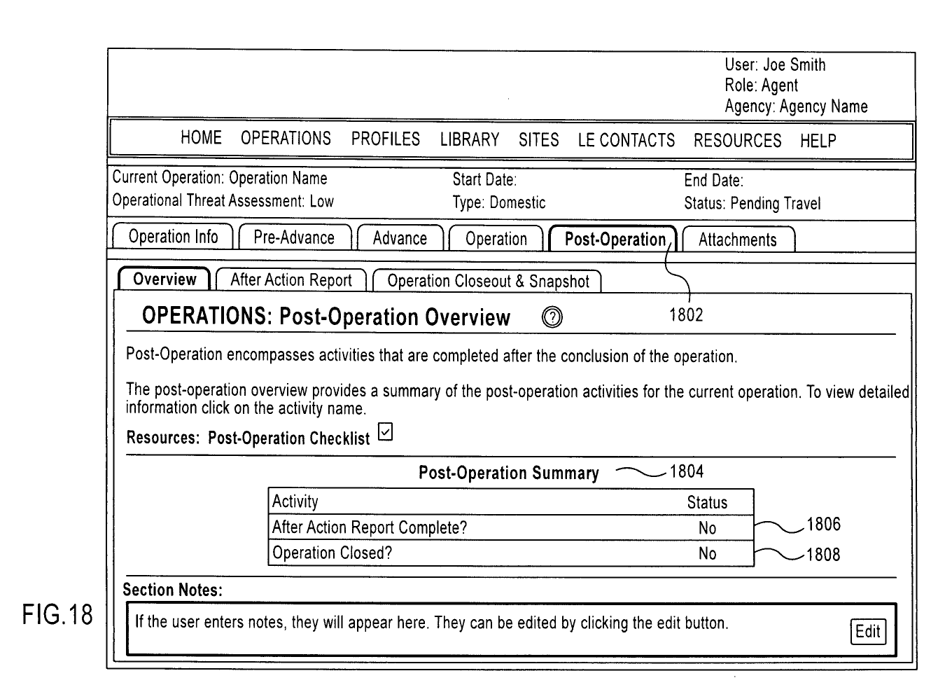

Following an operation, the user may debrief the operation, in accordance with an aspect of the present invention, as illustrated in FIG. 18. The debriefing session may be in an open format, where each member of the detail team may provide feedback regarding the effectiveness of the operation. The debriefing session may capture what went right and what went wrong during the operation, any lessons learned, and the effectiveness of each operation guideline used.

At this point the user may input this information into the system with an explanation regarding the guideline scores, and any recommendations to modify or update the guidelines. A post-operation summary 1804 may be displayed, indicating whether the after action report 1806 is completed and/or whether the operation is closed 1808.

The after-action report 1806 may include the following information, for example, unexpected/unusual incidents, observations, special communications used, equipment used, other routes not previously noted, other event sites not previously noted, total staffing hours, any security incidents that may have occurred, dates covered by the operation, any changes in the detail from the original detail, other airports visited, changes to the hotels or lodging not previously noted, local services used, total contingency expenses, lesson learned, locations visited during the operation, and/or contacts associated with the operation.

The system users may be able to view and react to the debriefing information stored in the system, and appropriately modify and/or update the baseline operation guidelines. If the need arises, the user may also have the ability to create new guidelines, base-line them with appropriate tasks, checklists, and other requirements, and appropriately catalog them into the system for use by other users. This debriefing process allows the system content to be kept up-to-date and as effective as possible.

Further, the user may generate an operation closeout and snapshot of the operation. This may include a comprehensive report including all information entered and/or associated with the current operation. Since this information may be continually updated, an operation snapshot may be saved and downloaded to a computer as a record of the operation at a particular point in time. After an operation snapshot is generated, a user may close an operation 1708.

In accordance with an aspect of the present invention, the system may be designed to the specification of an Enterprise Java web-application that can be run on any Java Enterprise Edition enabled web container.

In accordance with an aspect of the present invention, the system may be deployed under a hosted model, according to which government and/or commercial clients would have the option to purchase subscriptions to a centrally hosted website. Alternatively, for clients that request a self-hosted option, the system may be provided on a per-processor or per-user basis. This option would be relevant to protective services companies that require tight control of access to information.

In accordance with an aspect of the present invention, the system may provide validation of all user forms for correct input. This validation may execute on the server side, and for faster indication of errors, additionally on a client's browser. Any compatibility issues with client side validation on user browsers can be easily detected, and may indicate to the system to bypass client side validation and proceed with server side validation. As feasible, the system may allow various attachments (such as audio, video, images, etc.) to be viewed and/or heard via the browser to facilitate the user's analysis of the data. If any compatibility issues are detected with the presentation of the attachments from inside the browser, the system may make the attachments available for download, an option that may be available in any case.

While the present invention has been described in connection with aspects of the present invention, it will be understood by those skilled in the art that variations and modifications of the aspects of the present invention described above may be made without departing from the scope of the invention. Other aspects will be apparent to those skilled in the art from a consideration of the specification or from a practice of the invention disclosed herein.

What is claimed is:

1. A method for providing protective services to Principals, the method comprising:
selecting an operation for protecting a Principal;
performing pre-advance for the operation identifying information relating to the operation;
performing advance for the operation capturing the information relating to the operation;
storing the information relating to the operation in a data repository;
generating an operation plan based on the information captured for the operation; and
debriefing the operation.

2. The method of claim 1, further comprising:
upon completing the operation, creating a report based upon the information relating to the operation.

3. The method of claim 1, further comprising:
generating an operation snapshot based on the information captured for the operation.

4. The method of claim 1, further comprising:
providing guidelines and checklists for the operation.

5. The method of claim 1, wherein the operation protects more than one Principal.

6. The method of claim 1, wherein the information relating to the operation includes one of airport information, hospital information, lodging information, event site information, route information, motorcade information, and law enforcement contacts.

7. A system for providing protective services to Principals, the system comprising:
a module for selecting an operation for protecting a Principal;
a module for performing pre-advance for the operation identifying information relating to the operation;
a module for performing advance for the operation capturing the information relating to the operation;
a module for storing the information relating to the operation in a data repository;
a module for generating an operation plan based on the information captured for the operation; and
a module for debriefing an operation.

8. The system of claim 7, further comprising:
a module for creating a report upon completing the operation, based upon the information relating to the operation.

9. The system of claim 7, further comprising:
a module for generating an operation snapshot based on the information captured for the operation.

10. The system of claim 7, further comprising:
a module for providing guidelines and checklists for the operation.

11. The system of claim 7, wherein the operation protects more than one Principal.

12. The system of claim 7, wherein the information relating to the operation includes one of airport information, hospital information, lodging information, event site information, route information, motorcade information, and law enforcement contacts.

13. A system for providing protective services to Principals, the system comprising:
a processor;
a user interface functioning via the processor; and
a repository accessible by the processor;
wherein an operation is selected for protecting a Principal;
wherein pre-advance is performed for the operation indicating information relating to the operation;
wherein advance is performed for the operation capturing the information relating to the operation;
wherein information is stored relating to the operation in a data repository;
wherein an operation plan based on the information captured for the operation; and
wherein an operation is debriefed.

14. The system of claim 13, wherein the processor is housed on a server.

15. The system of claim 14, wherein the server is coupled to a network.

16. The system of claim 13, wherein the coupling is selected from a group consisting of a wired connection, a wireless connection, and a fiberoptic connection.

17. The system of claim 13, wherein the repository is housed on a server.

18. The system of claim 17, wherein the server is coupled to a network.

19. A computer program product comprising a computer usable medium having control logic stored therein for causing a computer to provide protective services to Principals, the control logic comprising:
first computer readable program code means for selecting an operation for protecting a Principal;
second computer readable program code means for performing pre-advance for the operation indicating information relating to the operation;
third computer readable program code means for performing advance for the operation capturing the information relating to the operation;
fourth computer readable program code means for storing the information relating to the operation in a data repository;
fifth computer readable program code means for generating an operation plan based on the information captured for the operation; and
sixth computer readable program code means for debriefing an operation.
